(19) United States
(12) Patent Application Publication
(10) Pub. No.: US 2023/0419209 A1
(43) Pub. Date: Dec. 28, 2023

(54) TASK MANAGEMENT DEVICE, VEHICLE, AND TASK MANAGEMENT METHOD

(71) Applicant: TOYOTA JIDOSHA KABUSHIKI KAISHA, Aichi-ken (JP)

(72) Inventors: Hirotaka NOGAMI, Nisshin-shi (JP); Jun TSUKAMOTO, Seto-shi (JP); Tsuyoshi OKADA, Nagoya-shi (JP); Fumiyuki KAGARA, Sagamihara-shi (JP); Kotaro HIROSE, Nisshin-shi (JP); Yoshiki TERASHIMA, Okazaki-shi (JP); Yohei ANDO, Okazaki-shi (JP)

(21) Appl. No.: 18/304,361

(22) Filed: Apr. 21, 2023

(30) Foreign Application Priority Data
Jun. 23, 2022 (JP) 2022-101405

(51) Int. Cl. G06Q 10/0631; G06Q 10/20

(52) U.S. Cl. CPC G06Q 10/06312; G06Q 10/06315; G06Q 10/20

(57) ABSTRACT

A task management device includes a control unit that calculates a required time for maintenance of an internal environment of at least one vehicle to be operated in a mode corresponding to an application before the mode of the at least one vehicle is switched from a first mode to a second mode based on information acquired from any one of a first target to be transported by the at least one vehicle in the first mode and a second target to be transported by the at least one vehicle in the second mode that is different from the first mode, and adjusts a dispatch schedule of the at least one vehicle in accordance with the required time calculated.

### CROSS-REFERENCE TO RELATED APPLICATION

This application claims priority to Japanese Patent Application No. 2022-101405 filed on Jun. 23, 2022, incorporated herein by reference in its entirety.

### BACKGROUND

### 1. Technical Field

The present disclosure relates to a task management device, a vehicle, and a task management method.

### 2. Description of Related Art

Japanese Unexamined Patent Application Publication No. 2020-170456 (JP 2020-170456 A) discloses a system for managing vehicles that can be used for multiple purposes.

### SUMMARY

When the use of a vehicle is changed, such as a change from a mobile store vehicle or a delivery vehicle to a bus, it is conceivable that it takes time to perform maintenance for the internal environment of the vehicle, such as cleaning of the inside of the vehicle.

An object of the present disclosure is to enable a flexible operation in accordance with the time required for maintenance of the internal environment of the vehicle.

A task management device according to the present disclosure includes a control unit that calculates a required time for maintenance of an internal environment of at least one vehicle to be operated in a mode corresponding to an application before the mode of the at least one vehicle is switched from a first mode to a second mode based on information acquired from any one of a first target to be transported by the at least one vehicle in the first mode and a second target to be transported by the at least one vehicle in the second mode that is different from the first mode, and adjusts a dispatch schedule of the at least one vehicle in accordance with the required time calculated.

A task management method according to the present disclosure includes: calculating, by a control unit, a required time for maintenance of an internal environment of at least one vehicle to be operated in a mode corresponding to an application before the mode of the at least one vehicle is switched from a first mode to a second mode based on information acquired from any one of a first target to be transported by the at least one vehicle in the first mode and a second target to be transported by the at least one vehicle in the second mode that is different from the first mode; and adjusting, by the control unit, a dispatch schedule of the at least one vehicle in accordance with the required time calculated.

According to the present disclosure, it is possible to perform a flexible operation in accordance with the time required for the maintenance of the internal environment of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a system according to an embodiment of the present disclosure;

FIG. 2 is a block diagram showing a configuration of a task management device according to the embodiment of the present disclosure;

FIG. 3 is a flowchart showing an operation of the task management device according to the embodiment of the present disclosure;

FIG. 4 is a flowchart showing a specific procedure of step S101 of the flowchart in FIG. 3;

FIG. 5 is a flowchart showing a modification of the operation of the task management device according to the embodiment of the present disclosure; and

FIG. 6 is a flowchart showing a specific procedure of step 5201 of the flowchart in FIG. 5.

### DETAILED DESCRIPTION OF EMBODIMENTS

Hereinafter, an embodiment of the present disclosure will be described with reference to the drawings.

In each drawing, the same or corresponding portions are denoted by the same reference signs. In the description of the present embodiment, description of the same or corresponding components will be appropriately omitted or simplified.

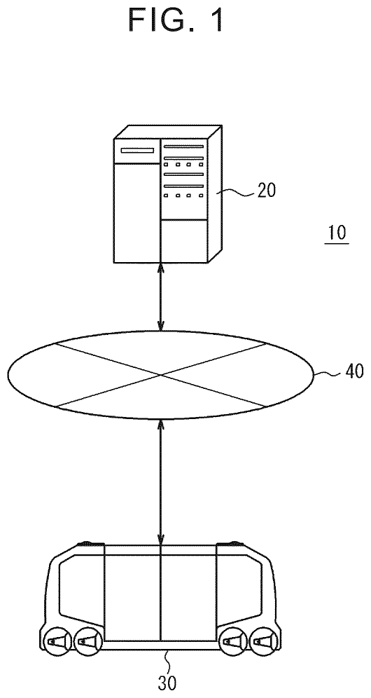

The configuration of a system 10 according to the present embodiment will be described with reference to FIG. 1.

The system 10 according to the present embodiment includes at least one task management device 20, and at least one vehicle 30. The task management device 20 can communicate with the vehicle 30 via a network 40.

The task management device 20 is installed in a facility such as a data center and operated by a business operator that manages the vehicle 30. The task management device 20 is a computer such as a server belonging to a cloud computing system or other computing system.

The vehicle 30 is operated in a mode in accordance with its application, such as delivery of articles, transportation of passengers, or sale of products. The mode of the vehicle 30 is switched by changing the interior, the exterior, or both. The vehicle 30 is, for example, a mounted vehicle in which rear seats can be freely removed or moved or a table can be freely installed without using tools, by using a dedicated floor structure that utilizes a plurality of rails. For example, the vehicle 30 is equipped with a display such as an LCD or an organic EL as part of the exterior, and can freely change the exterior by switching the contents displayed on the display. The term “LCD” is an abbreviation for “liquid crystal display”. The term “EL” is an abbreviation for “electroluminescent”. The vehicle 30 may be utilized as an on-demand bus, may be equipped with a power source, lighting, a table, a monitor, or any combination thereof and used as a business meeting space or an office at the destination, or may also be used for other purposes such as sale of products, delivery of articles, or provision of administrative services. Changing the interior, the exterior, or both of the vehicle 30 makes it possible to use the vehicle 30 differently depending on the day of the week or the time period.

The vehicle 30 is a vehicle of any type, such as a gasoline vehicle, a diesel vehicle, a hydrogen vehicle, an HEV, a PHEV, a BEV, or an FCEV. The term “HEV” is an abbreviation for “hybrid electric vehicle”. The term “PHEV” is an abbreviation for “plug-in hybrid electric vehicle”. The term “BEV” is an abbreviation for “battery electric vehicle”. The term “FCEV” is an abbreviation for “fuel cell electric vehicle”. The vehicle 30 is an AV according to the present embodiment. However, the vehicle 30 may be driven by the driver, or the driving may be automated at any level. The term “AV” is an abbreviation for autonomous vehicle. The level of autonomous driving is, for example, one of levels 1 to 5 in the SAE leveling, for example. The term “SAE” is an abbreviation for the “Society of Automotive Engineers”. The vehicle 30 may be a MaaS dedicated vehicle. The term “MaaS” is an abbreviation for “mobility as a service”.

The network 40 includes the Internet, at least one WAN, at least one MAN, or any combination thereof. The term “WAN” is an abbreviation for “wide area network”. The term “MAN” is an abbreviation for “metropolitan area network”. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation for “local area network”.

The outline of the present embodiment will be described with reference to FIG. 1.

The task management device 20 calculates the time required for maintenance of the internal environment of at least one vehicle 30 before the mode of the at least one vehicle 30 is switched from a first mode M1 to a second mode M2 that is different from the first mode M1 based on information acquired with respect to any of a first target B1 and a second target B2. The first target B1 is a target that is transported by at least one vehicle 30 in the first mode M1. The second target B2 is a target that is transported by at least one vehicle 30 in the second mode M2. The maintenance includes, for example, cleaning or deodorizing. The task management device 20 adjusts a dispatch schedule of at least one vehicle 30 in accordance with the calculated required time.

The application corresponding to each of the first mode M1 and the second mode M2 may be any application. However, the application in the present embodiment is delivery of articles, transportation of passengers, or sale of products.

In the present embodiment, the dispatch schedule of the vehicle 30 can optimized in accordance with the time required for the maintenance of the internal environment of the vehicle 30 at the time of switching the application of the vehicle 30, such as a change from a mobile store vehicle or a delivery vehicle to a bus. In other words, it is possible to perform a flexible operation in accordance with the time required for the maintenance of the internal environment of the vehicle 30.

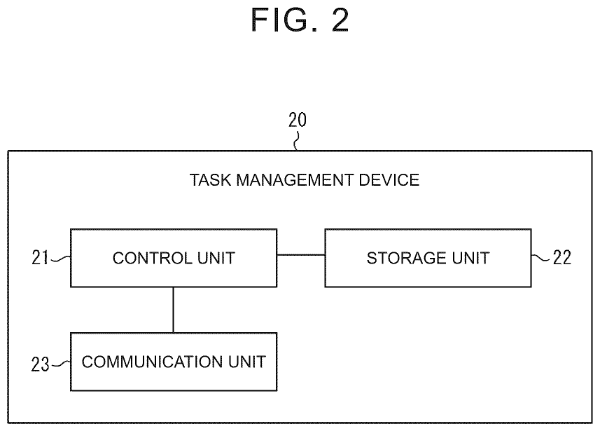

The configuration of the task management device 20 according to the present embodiment will be described with reference to FIG. 2.

The task management device 20 includes a control unit 21, a storage unit 22, and a communication unit 23.

The control unit 21 includes at least one processor, at least one programmable circuit, at least one dedicated circuit, or any combination thereof. The processor is a general-purpose processor such as a CPU or a GPU, or a dedicated processor specialized for a specific process. The term “CPU” is an abbreviation for “central processing unit”. The term “GPU” is an abbreviation for “graphics processing unit”. The programmable circuit is, for example, an FPGA. The term “FPGA” is an abbreviation for “field-programmable gate array”. The dedicated circuit is, for example, an ASIC. The term “ASIC” is an abbreviation for “application specific integrated circuit”. The control unit 21 executes processes related to the operation of the task management device 20 while controlling various units of the task management device 20.

The storage unit 22 includes at least one semiconductor memory, at least one magnetic memory, at least one optical memory, or any combination thereof. The semiconductor memory is, for example, a RAM, a ROM, or a flash memory. The term “RAM” is an abbreviation for “random access memory”. The term “ROM” is an abbreviation for “read-only memory”. The RAM is, for example, an SRAM or a DRAM. The term “SRAM” is an abbreviation for “static random access memory”. The term “DRAM” is an abbreviation for “dynamic random access memory”. The ROM is, for example, an EEPROM. The term “EEPROM” is an abbreviation for “electrically erasable programmable read only memory”. The flash memory is, for example, an SSD. The term “SSD” is an abbreviation for solid-state drive. The magnetic memory is, for example, an HDD. The term “HDD” is an abbreviation for hard disk drive. The storage unit 22 functions as, for example, a main storage device, an auxiliary storage device, or a cache memory. The storage unit 22 stores data used for the operation of the task management device 20 and data acquired through the operation of the task management device 20.

The communication unit 23 includes at least one communication interface. The communication interface is, for example, an interface compatible with wired local area network (LAN) communication standards such as Ethernet (registered trademark), or an interface compatible with wireless LAN communication standards such as IEEE802. 11. The term “IEEE” is an abbreviation for Institute of Electrical and Electronics Engineers. The communication unit 23 communicates with the vehicle 30. The communication unit 23 receives the data used for the operation of the task management device 20, and transmits the data acquired through the operation of the task management device 20.

The function of the task management device 20 is realized by executing the program according to the present embodiment with the processor serving as the control unit 21. That is, the function of the task management device 20 is realized by software. The program causes the computer to perform the operation of the task management device 20 such that the computer functions as the task management device 20. That is, the computer functions as the task management device 20 by performing the operation of the task management device 20 in accordance with the program.

The program can be stored in a non-transitory computer-readable medium. The non-transitory computer-readable medium is, for example, a flash memory, a magnetic recording device, an optical disc, an opto-magnetic recording medium, or a ROM. The distribution of the program is carried out, for example, by selling, transferring, or renting a portable medium such as an SD card, a DVD, or a CD-ROM in which the program is stored. The term “SD” is an abbreviation for “secure digital”. The term “DVD” is an abbreviation for “digital versatile disc”. The term “CD-ROM” is an abbreviation for “compact disc read only memory”. The program may be stored in the storage of the server and transferred from the server to other computers to distribute the program. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the processing of the computer corresponds to the “data equivalent to a program”.

A part or all of the functions of the task management device 20 may be realized by a programmable circuit or a dedicated circuit serving as the control unit 21. That is, a part or all of the functions of the task management device 20 may be realized by hardware.

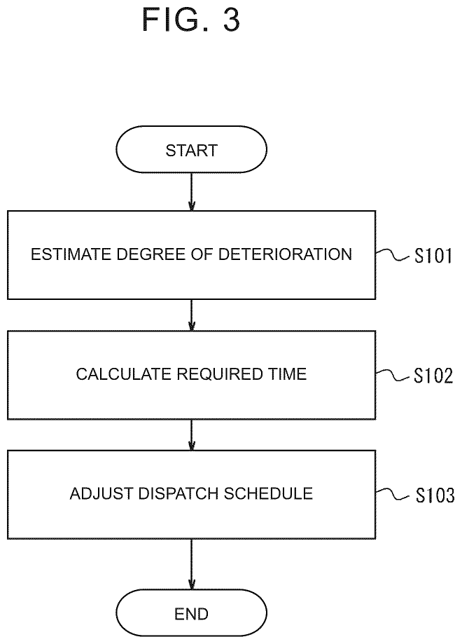

The operation of the task management device 20 according to the present embodiment will be described with reference to FIG. 3. This operation corresponds to a task management method according to the present embodiment.

In step S101, the control unit 21 of the task management device 20 estimates the degree of deterioration of the internal environment of the vehicle 30 due to the transportation of the first target B1 with reference to degree of deterioration data Dd. The degree of deterioration data Dd is data that defines the degree of deterioration of the internal environment of the vehicle 30 due to transportation of each of two or more targets for each type of the targets. For such data, for example, the correspondence table that defines a corresponding degree of deterioration for each type of targets, such as articles delivered by the vehicle 30, products sold by the vehicle 30, or passengers transported by the vehicle 30, can be used. In this correspondence table, the degree of deterioration corresponding to articles or products that emit an odor, such as fresh fish or meat, may be defined to be higher than the degree of deterioration corresponding to articles or products that do not emit an odor, such as packages in boxes. The degree of deterioration corresponding to passengers who tend to soil the inside of the vehicle, such as children, may be defined to be higher than the degree of deterioration corresponding to passengers who less tend to soil the inside of the vehicle, such as adults. The degree of deterioration is expressed, for example, by the amount of dirt or the intensity of odor. The degree of deterioration data Dd is stored in advance in the storage unit 22 of the task management device 20 or an external storage. The first target B1 is a target that is transported by the vehicle 30 in the first mode M1.

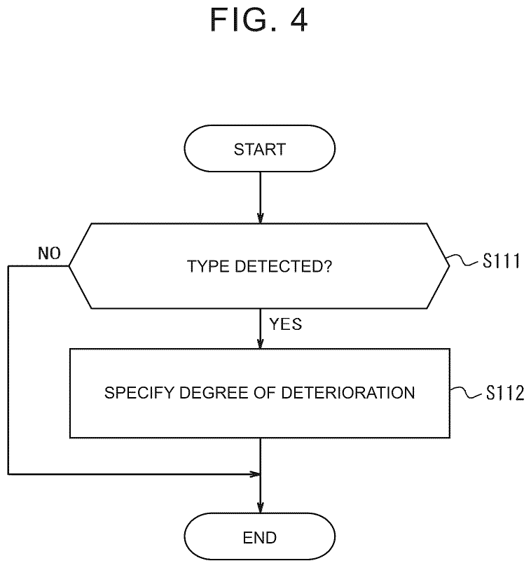

FIG. 4 shows a specific procedure of the process in step S101.

In step S111, the control unit 21 of the task management device 20 waits until the type of the first target B1 is detected during the period P1 in which the vehicle 30 is operated in the first mode M1. Specifically, the type of the first target B1 is detected by the following procedure.

The vehicle 30 captures an image of the inside of the vehicle 30 using a camera mounted on the vehicle 30 during the period P1. The vehicle 30 transmits the captured image to the task management device 20 via a communication interface that is mounted on the vehicle 30 and is compatible with mobile communication standards such as LTE, the 4G standard, or the 5G standard, V2X communication standards such as DSRC or cellular V2X, or wireless LAN communication standards such as IEEE 802.11. The term “LTE” is an abbreviation for “long term evolution”. The term “4G” is an abbreviation for “fourth generation”. The term “5G” is an abbreviation for “fifth generation”. The term “DSRC” is an abbreviation for “dedicated short range communications”. The term “V2X” is an abbreviation for “vehicle-to-everything”.

The control unit 21 of the task management device 20 receives the image of the inside of the vehicle 30 from the vehicle 30 via the communication unit 23. The control unit 21 detects the type of the first target B1 by analyzing the received image. As a method of image analysis, a known method can be used. Machine learning such as deep learning may be used.

When the type of the first target B1 is detected, the process in step S112 is executed. When the type of the first target B1 is not detected during the period P1, the procedure shown in FIG. 4 ends.

In step S112, the control unit 21 of the task management device 20 estimates the degree of deterioration of the internal environment of the vehicle 30 due to the transportation of the first target B1 by specifying the degree of deterioration defined in the degree of deterioration data Dd for the type of the first target B1. For example, on assumption that the application corresponding to the first mode M1 is the delivery of articles or the sale of products, when the article or product that emits odor such as fresh fish or meat is detected in step S111, the control unit 21 estimates the degree of deterioration represented by the intensity of odor of the internal environment of the vehicle 30 to be higher than when the article or product that does not emit odor, such as package in a box, is detected in step S111. On assumption that the application corresponding to the first mode M1 is transportation of passengers, when the passenger who tends to soil the inside of the vehicle, such as a child, is detected in step S111, the control unit 21 estimates the degree of deterioration represented by the amount of dirt of the internal environment of the vehicle 30 to be higher when the passenger who less tends to soil the inside of the vehicle, such as an adult, is detected in step S111.

In step S102, the control unit 21 of the task management device 20 calculates the time required for the maintenance of the internal environment of the vehicle 30 before the mode of the vehicle 30 is switched from the first mode M1 to the second mode M2 that is different from the first mode M1 based on an estimation result obtained with respect to the first target B1 in step S101. Specifically, the time required for the maintenance is calculated by the following procedure.

When the control unit 21 of the task management device 20 estimates the amount of dirt inside the vehicle 30 as the degree of deterioration in step S101, the control unit 21 calculates the time required for a cleaning staff member or a cleaning robot on board the vehicle 30 to clean the inside of the vehicle 30 as the time required for the maintenance. More specifically, the control unit 21 derives the cleaning time corresponding to the amount of dirt inside the vehicle 30 estimated in step S101 as the time required for the maintenance with reference to a conversion table stored in the storage unit 22 in advance or using a predefined conversion formula. The derived cleaning time becomes longer as the estimated amount of dirt inside the vehicle 30 increases, that is, as the degree of deterioration becomes higher.

When the intensity of odor inside the vehicle 30 is detected as the degree of deterioration in step S101, the control unit 21 of the task management device 20 calculates the time required for an air purifier mounted on the vehicle 30 to perform deodorizing inside the vehicle 30 as the time required for the maintenance. More specifically, the control unit 21 derives the operating time of the air purifier corresponding to the intensity of odor inside the vehicle 30 estimated in step S101 as the time required for the maintenance with reference to a conversion table stored in the storage unit 22 in advance or using a predefined conversion formula. The derived operating time becomes longer as the estimated odor inside the vehicle 30 becomes more intense, that is, as the degree of deterioration becomes higher.

When the degree of deterioration cannot be estimated in step S101, the control unit 21 of the task management device 20 may use a preset default value as the calculated value of the time required for the maintenance.

In step S103, the control unit 21 of the task management device 20 adjusts the dispatch schedule of the vehicle 30 in accordance with the required time calculated in step S102. The adjustment of the dispatch schedule of the vehicle 30 includes adjustment of the time to switch the mode of the vehicle 30 to the second mode M2 and adjustment of the time to start operating the vehicle 30 in the second mode M2. For example, when the time required for the maintenance is long, the control unit 21 delays the time to switch the mode of the vehicle 30 to the second mode M2. The control unit 21 also delays the time to start operating the vehicle 30 in the second mode M2. When the time required for the maintenance is short, the control unit 21 does not change or advances the time to switch the mode of the vehicle 30 to the second mode M2. The control unit 21 also does not change or advances the time to start operating the vehicle 30 in the second mode M2.

Specifically, first the control unit 21 of the task management device 20 transmits first instruction data Di1 for instructing the operator to change the interior or the exterior of the vehicle 30 to the interior or the exterior corresponding to the second mode M2 to the terminal device of the operator, such as a mobile phone, a smart phone, or a tablet, via the communication unit 23. The first instruction data Di1 includes data that designates time. Upon receipt of the first instruction data Di1, the terminal device of the operator displays the received first instruction data Di1 on the display or outputs the received first instruction data Di1 by voice from the speaker. The operator changes the interior or the exterior of the vehicle 30 at a designated time in accordance with the first instruction data Di1 displayed or output by voice. For example, on assumption that the application corresponding to the second mode M2 is a bus, the operator installs rear seats for bus passengers to be seated or moves rear seats to specific positions. Alternatively, the operator may cause a display provided as part of the exterior of the vehicle 30 to display operation information such as the destination of the bus.

When the vehicle 30 has a function of automatically changing the interior or the exterior of the vehicle 30, the control unit 21 of the task management device 20 may transmit second instruction data Di2 for instructing the vehicle 30 to change the interior or the exterior of the vehicle 30 to the interior or the exterior corresponding to the second mode M2 to the vehicle 30 via the communication unit 23, instead of or in addition to transmission of the first instruction data Di1 to the terminal device of the operator. In such a modification, the second instruction data Di2 includes data that designates time. The vehicle 30 receives the second instruction data Di2 from the task management device 20 via the communication interface mounted on vehicle 30. The vehicle 30 changes the interior or the exterior of the vehicle 30 at a designated time in accordance with the received second instruction data Di2. For example, on assumption that the application corresponding to the second mode M2 is a bus, the vehicle 30 moves rear seats for bus passengers to be seated to specific positions. Alternatively, the vehicle 30 may display the operation information such as the destination of the bus on a display provided as part of the exterior of the vehicle 30.

Next, the control unit 21 of the task management device 20 transmits third instruction data Di3 for instructing the vehicle 30 to start operating the vehicle 30 in the second mode M2 to the vehicle 30 via the communication unit 23. The third instruction data Di3 includes data that designates time. The vehicle 30 receives the third instruction data Di3 from the task management device 20 via the communication interface mounted on vehicle 30. The vehicle 30 starts moving at the designated time in accordance with the received third instruction data Di3. For example, on assumption that the application corresponding to the second mode M2 is a bus, the vehicle 30 departs toward a point where the passengers are picked up first.

As described above, in the present embodiment, when the vehicle 30 is operated for distribution purposes, the degree of deterioration of the environmental deterioration such as the odor inside the vehicle 30 is estimated in accordance with the characteristics of objects to be transported and the time required for improving the environment, such as deodorizing inside the vehicle 30, is calculated, whereby the time to start operating the vehicle 30 after switching the vehicle 30 to a bus can be adjusted depending on whether improvement of the environment takes time. As described above, in the present embodiment, when the vehicle 30 is operated as a bus, the degree of deterioration of the environmental deterioration such as the dirt inside the vehicle 30 is estimated in accordance with the characteristics of people to be transported and the time required for improving the environment, such as removal of the dirt inside the vehicle 30, is calculated, whereby the time to start operating the vehicle 30 while the purpose of the vehicle 30 is switched to the distribution purpose can be adjusted depending on whether improvement of the environment takes time. In other words, it is possible to perform a flexible operation in accordance with the time required to improve the internal environment of the vehicle 30. When the vehicle 30 is a BEV, the timing of charging the vehicle 30 and the timing of improving the environment inside the vehicle 30 may be matched.

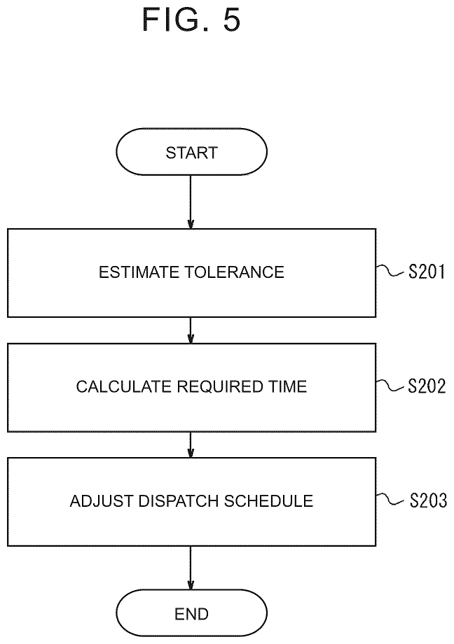

A modification of the operation of the task management device 20 according to the present embodiment will be described with reference to FIG. 5.

In step S201, the control unit 21 of the task management device 20 estimates the degree of deterioration of the internal environment of the vehicle 30 that is allowable when the second target B2 is transported with reference to tolerance data Da. The tolerance data Da is data that defines the degree of deterioration of the internal environment of the vehicle 30 that is allowable when each of two or more targets is transported for each type of the targets. For such data, for example, the correspondence table that defines corresponding tolerance for each type of targets, such as articles delivered by the vehicle 30, products sold by the vehicle 30, or passengers transported by the vehicle 30, can be used. In this correspondence table, the tolerance corresponding to the articles or the products may be defined higher than the tolerance corresponding to the passengers. The tolerance is expressed, for example, by the amount of dirt or the intensity of odor. The tolerance data Da is stored in advance in the storage unit 22 of the task management device 20 or an external storage. The second target B2 is a target that is transported by the vehicle 30 in the second mode M2.

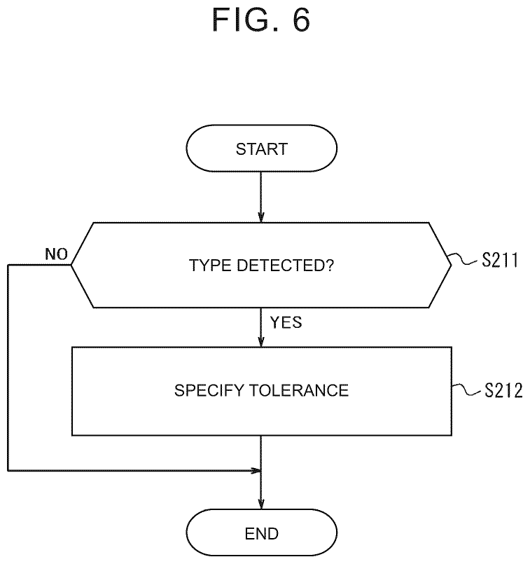

FIG. 6 shows a specific procedure of the process in step S201.

In step S211, the control unit 21 of the task management device 20 waits until the type of the second target B2 is notified before a period P2 in which the vehicle 30 is operated in the second mode M2. The type of the second target B2 may be notified to the task management device 20 at an arbitrary timing and by arbitrary method, such as transmission of the type as part of data input by the user when the user reserves use of the vehicle 30 in the case where the vehicle 30 is operated in the second mode M2. The type of the second target B2 may be indirectly notified to the task management device 20 by notifying the task management device 20 of the application corresponding to the second mode M2, instead of directly notifying the task management device 20 of the type of the second target B2. For example, when the application corresponding to the second mode M2 is the delivery of articles, it can be understood that at least the type of the second target B2 is the article. When the application corresponding to the second mode M2 is the sale of products, it can be understood that at least the type of the second target B2 is the product. When the application corresponding to the second mode M2 is the transportation of passengers, it can be understood that at least the type of the second target B2 is the passenger. When the task management device 20 is notified of the type of the second target B2, the process in step S212 is executed. When the task management device 20 is not notified of the type of the second target B2 before the period P2, the procedure shown in FIG. 6 ends.

In step S212, the control unit 21 of the task management device 20 estimates the degree of deterioration of the internal environment of the vehicle 30 that is allowable when the second target B2 is transported by specifying the degree of deterioration defined in the tolerance data Da for the type of the second target B2. For example, when the notification is made in step S211 that the application corresponding to the second mode M2 is the delivery of articles or the sale of products, the control unit 21 estimates the tolerance represented by the amount of dirt or the intensity of odor of the internal environment of the vehicle 30 to be higher than when the notification is made in step S211 that the application corresponding to the second mode M2 is the transportation of passengers.

In step S202, the control unit 21 of the task management device 20 calculates the time required for the maintenance of the internal environment of the vehicle 30 before the mode of the vehicle 30 is switched from the first mode M1 to the second mode M2 based on an estimation result obtained with respect to the second target B2 in step S201. Specifically, the time required for the maintenance is calculated by the following procedure.

When the control unit 21 of the task management device 20 estimates the amount of dirt inside the vehicle 30 as the tolerance in step S201, the control unit 21 calculates the time required for a cleaning staff member or a cleaning robot on board the vehicle 30 to clean the inside of the vehicle 30 as the time required for the maintenance. More specifically, the control unit 21 derives the cleaning time corresponding to the amount of dirt inside the vehicle 30 estimated in step S201 as the time required for the maintenance with reference to a conversion table stored in the storage unit 22 in advance or using a predefined conversion formula. The derived cleaning time becomes longer as the allowable amount of dirt inside the vehicle 30 becomes smaller, that is, as the tolerance becomes lower.

When the intensity of odor inside the vehicle 30 is detected as the tolerance in step S201, the control unit 21 of the task management device 20 calculates the time required for an air purifier mounted on the vehicle 30 to perform deodorizing inside the vehicle 30 as the time required for the maintenance. More specifically, the control unit 21 derives the operating time of the air purifier corresponding to the intensity of odor inside the vehicle 30 estimated in step S201 as the time required for the maintenance with reference to a conversion table stored in the storage unit 22 in advance or using a predefined conversion formula. The derived operating time is longer as the allowable intensity of odor inside the vehicle 30 becomes smaller, that is, the tolerance becomes lower.

When the tolerance cannot be estimated in step S201, the control unit 21 of the task management device 20 may use a preset default value as the calculated value of the time required for the maintenance.

Since the process in step S203 is similar to the process in step S103 of FIG. 3, the description thereof will be omitted.

As described above, in the example shown in FIG. 5, when the vehicle 30 is operated for a certain purpose, the degree of tolerance of the environmental deterioration such as the dirt inside the vehicle 30 is estimated in accordance with what is transported and the time required for improving the environment such as removal of the dirt inside the vehicle 30 is calculated, whereby the time to start operating the vehicle 30 for that purpose can be adjusted depending on whether improvement of the environment takes time. In other words, it is possible to perform a flexible operation in accordance with the time required to improve the internal environment of the vehicle 30.

As a modification of the present embodiment, the process in step S201 in FIG. 5 may be added to the operation shown in FIG. 3. That is, in step S102, the control unit 21 of the task management device 20 may calculate the time required for the maintenance of the internal environment of the vehicle 30 before the mode of the vehicle 30 is switched from the first mode M1 to the second mode M2 that is different from the first mode M1 based on both of the estimation result obtained with respect to the first target B1 in step S101 and the estimation result obtained with respect to the second target B2 in step S201.

As a modification of the present embodiment, at least one vehicle 30 may be multiple vehicles traveling on a common route or within a common area. The control unit 21 of the task management device 20 may adjust the dispatch schedules of multiple vehicles so as to operate two or more vehicles in different modes for the same period. The control unit 21 may adjust the dispatch schedule of the multiple vehicles 30 so as to operate two or more vehicles in the same mode for different periods. For example, when, in which mode, and for how long to operate multiple vehicles may be determined such that there is a difference between the vehicles. That is, for each vehicle, the time frame to be operated for distribution, the time frame for cleaning the inside of the vehicle, and the time frame to be operated as a bus may be set with a slight lag.

By further modifying the modification above, the control unit 21 of the task management device 20 may adjust the dispatch schedule of multiple vehicles in accordance with a demand for each mode for each time slot. For example, how many vehicles are to be operated when, in which mode, and for how long may be determined in accordance with a demand for each time slot and for each mode. The number of vehicles to be used for distribution purposes and the number of vehicles to be used as buses may vary in each time slot. When a delayed vehicle occurs, the order may be changed.

As a modification of the present embodiment, the task management device 20 may be provided in the vehicle 30.

A part of the embodiment of the present disclosure is shown as an example below. However, it should be noted that embodiment of the present disclosure is not limited to these.

### Appendix 1

A task management device includes a control unit that calculates a required time for maintenance of an internal environment of at least one vehicle to be operated in a mode corresponding to an application before the mode of the at least one vehicle is switched from a first mode to a second mode based on information acquired from any one of a first target to be transported by the at least one vehicle in the first mode and a second target to be transported by the at least one vehicle in the second mode that is different from the first mode, and adjusts a dispatch schedule of the at least one vehicle in accordance with the required time calculated.

### Appendix 2

In the task management device according to Appendix 1, the control unit estimates a degree of deterioration of the internal environment of the at least one vehicle due to transportation of the first target with reference to degree of deterioration data in which a degree of deterioration of the internal environment of the vehicle due to transportation of each of two or more types of targets is defined for each of the types of the targets, and uses an estimation result obtained as the information.

### Appendix 3

In the task management device according to Appendix 2, when a type of the first target is detected during a period in which the at least one vehicle is operated in the first mode, the control unit estimates the degree of deterioration of the internal environment of the at least one vehicle due to transportation of the first target by specifying the degree of deterioration defined in the degree of deterioration data for the type of the first target.

### Appendix 4

In the task management device according to Appendix 1, the control unit estimates a degree of deterioration of the internal environment of the at least one vehicle that is tolerated when the second target is transported with reference to tolerance data in which a degree of deterioration of the internal environment of the vehicle that is tolerated when each of two or more types of targets is transported is defined for each of the types of the targets, and uses an estimation result obtained as the information.

### Appendix 5

In the task management device according to Appendix 4, when a type of the second target is notified before a period in which the at least one vehicle is operated in the second mode, the control unit estimates the degree of deterioration of the internal environment of the at least one vehicle that is tolerated when the second target is transported by specifying the degree of deterioration defined in the tolerance data for the type of the second target.

### Appendix 6

In the task management device according to any one of Appendices 1 to 5, the at least one vehicle is a plurality of vehicles traveling on a common route or within a common area.

### Appendix 7

In the task management device according to Appendix 6, the control unit adjusts the dispatch schedule of the vehicles so as to operate two or more of the vehicles in different modes for a same period.

### Appendix 8

In the task management device according to Appendix 6 or 7, the control unit adjusts the dispatch schedule of the vehicles so as to operate two or more of the vehicles in a same mode for different periods.

### Appendix 9

In the task management device according to any one of Appendices 6 to 8, the control unit adjusts the dispatch schedule of the vehicles in accordance with a demand of each mode for each time slot.

### Appendix 10

In the task management device according to any one of Appendices 1 to 9, an application corresponding to each of the first mode and the second mode is delivery of articles, transportation of passengers, or sale of products.

### Appendix 11

In the task management device according to any one of Appendices 1 to 10, the maintenance includes cleaning.

### Appendix 12

In the task management device according to any one of Appendices 1 to 11, the maintenance includes deodorizing.

### Appendix 13

A vehicle includes the task management device according to any one of Appendices 1 to 12.

### Appendix 14

A task management method includes: calculating, by a control unit, a required time for maintenance of an internal environment of at least one vehicle to be operated in a mode corresponding to an application before the mode of the at least one vehicle is switched from a first mode to a second mode based on information acquired from any one of a first target to be transported by the at least one vehicle in the first mode and a second target to be transported by the at least one vehicle in the second mode that is different from the first mode; and adjusting, by the control unit, a dispatch schedule of the at least one vehicle in accordance with the required time calculated.

### Appendix 15

The task management method according to Appendix 14 further includes estimating a degree of deterioration of the internal environment of the at least one vehicle due to transportation of the first target with reference to degree of deterioration data in which a degree of deterioration of the internal environment of the vehicle due to transportation of each of two or more types of targets is defined for each of the types of the targets, and the calculating the required time includes using an estimation result obtained as the information.

### Appendix 16

In the task management method according to Appendix 15, the estimating the degree of deterioration of the internal environment of the at least one vehicle due to the transportation of the first target includes estimating, when a type of the first target is detected during a period in which the at least one vehicle is operated in the first mode, specifying the degree of deterioration defined in the degree of deterioration data for the type of the first target.

### Appendix 17

The task management method according to Appendix 14 further includes estimating a degree of deterioration of the internal environment of the at least one vehicle that is tolerated when the second target is transported with reference to tolerance data in which a degree of deterioration of the internal environment of the vehicle that is tolerated when each of two or more types of targets is transported is defined for each of the types of the targets, and the calculating the required time includes using an estimation result obtained as the information.

### Appendix 18

In the task management method according to Appendix 17, the estimating the degree of deterioration of the internal environment of the at least one vehicle that is tolerated when the second target is transported includes specifying, when a type of the second target is notified before a period in which the at least one vehicle is operated in the second mode, the degree of deterioration defined in the tolerance data for the type of the second target.

### Appendix 19

In the task management method according to any one of Appendices 14 to 18, the at least one vehicle is a plurality of vehicles traveling on a common route or within a common area.

### Appendix 20

In the task management method according to any one of Appendices 14 to 19, an application corresponding to each of the first mode and the second mode is delivery of articles, transportation of passengers, or sale of products.

The present disclosure is not limited to the embodiments described above. For example, two or more blocks shown in the block diagram may be integrated, or a single block may be divided. Instead of executing two or more steps shown in the flowchart in chronological order according to the description, the steps may be executed in parallel or in a different order, depending on the processing capacities of the devices that execute the steps, or as necessary. Other changes may be made without departing from the scope of the present disclosure.

What is claimed is:

1. A task management device comprising a control unit that calculates a required time for maintenance of an internal environment of at least one vehicle to be operated in a mode corresponding to an application before the mode of the at least one vehicle is switched from a first mode to a second mode based on information acquired from any one of a first target to be transported by the at least one vehicle in the first mode and a second target to be transported by the at least one vehicle in the second mode that is different from the first mode, and adjusts a dispatch schedule of the at least one vehicle in accordance with the required time calculated.

2. The task management device according to claim 1, wherein the control unit estimates a degree of deterioration of the internal environment of the at least one vehicle due to transportation of the first target with reference to degree of deterioration data in which a degree of deterioration of the internal environment of the vehicle due to transportation of each of two or more types of targets is defined for each of the types of the targets, and uses an estimation result obtained as the information.

3. The task management device according to claim 2, wherein when a type of the first target is detected during a period in which the at least one vehicle is operated in the first mode, the control unit estimates the degree of deterioration of the internal environment of the at least one vehicle due to transportation of the first target by specifying the degree of deterioration defined in the degree of deterioration data for the type of the first target.

4. The task management device according to claim 1, wherein the control unit estimates a degree of deterioration of the internal environment of the at least one vehicle that is tolerated when the second target is transported with reference to tolerance data in which a degree of deterioration of the internal environment of the vehicle that is tolerated when each of two or more types of targets is transported is defined for each of the types of the targets, and uses an estimation result obtained as the information.

5. The task management device according to claim 4, wherein when a type of the second target is notified before a period in which the at least one vehicle is operated in the second mode, the control unit estimates the degree of deterioration of the internal environment of the at least one vehicle that is tolerated when the second target is transported by specifying the degree of deterioration defined in the tolerance data for the type of the second target.

6. The task management device according to claim 1, wherein the at least one vehicle is a plurality of vehicles traveling on a common route or within a common area.

7. The task management device according to claim 6, wherein the control unit adjusts the dispatch schedule of the vehicles so as to operate two or more of the vehicles in different modes for a same period.

8. The task management device according to claim 6, wherein the control unit adjusts the dispatch schedule of the vehicles so as to operate two or more of the vehicles in a same mode for different periods.

9. The task management device according to claim 6, wherein the control unit adjusts the dispatch schedule of the vehicles in accordance with a demand of each mode for each time slot.

10. The task management device according to claim 1, wherein an application corresponding to each of the first mode and the second mode is delivery of articles, transportation of passengers, or sale of products.

11. The task management device according to claim 1, wherein the maintenance includes cleaning.

12. The task management device according to claim 1, wherein the maintenance includes deodorizing.

13. A vehicle comprising the task management device according to claim 1.

14. A task management method comprising:
calculating, by a control unit, a required time for maintenance of an internal environment of at least one vehicle to be operated in a mode corresponding to an application before the mode of the at least one vehicle is switched from a first mode to a second mode based on information acquired from any one of a first target to be transported by the at least one vehicle in the first mode and a second target to be transported by the at least one vehicle in the second mode that is different from the first mode; and
adjusting, by the control unit, a dispatch schedule of the at least one vehicle in accordance with the required time calculated.

15. The task management method according to claim 14, further comprising estimating a degree of deterioration of the internal environment of the at least one vehicle due to transportation of the first target with reference to degree of deterioration data in which a degree of deterioration of the internal environment of the vehicle due to transportation of each of two or more types of targets is defined for each of the types of the targets, wherein the calculating the required time includes using an estimation result obtained as the information.

16. The task management method according to claim 15, wherein the estimating the degree of deterioration of the internal environment of the at least one vehicle due to the transportation of the first target includes estimating, when a type of the first target is detected during a period in which the at least one vehicle is operated in the first mode, specifying the degree of deterioration defined in the degree of deterioration data for the type of the first target.

17. The task management method according to claim 14, further comprising estimating a degree of deterioration of the internal environment of the at least one vehicle that is tolerated when the second target is transported with reference to tolerance data in which a degree of deterioration of the internal environment of the vehicle that is tolerated when each of two or more types of targets is transported is defined for each of the types of the targets, wherein the calculating the required time includes using an estimation result obtained as the information.

18. The task management method according to claim 17, wherein the estimating the degree of deterioration of the internal environment of the at least one vehicle that is tolerated when the second target is transported includes specifying, when a type of the second target is notified before a period in which the at least one vehicle is operated in the second mode, the degree of deterioration defined in the tolerance data for the type of the second target.

19. The task management method according to claim 14, wherein the at least one vehicle is a plurality of vehicles traveling on a common route or within a common area.

20. The task management method according to claim 14, wherein an application corresponding to each of the first mode and the second mode is delivery of articles, transportation of passengers, or sale of products.
